(19) United States
(12) Patent Application Publication
(10) Pub. No.: US 2005/0236745 A1
(43) Pub. Date: Oct. 27, 2005

(54) System and method for manufacturing injection molded parts

(76) Inventors: Heinrich Lang, Ergersheim (DE); Markus Meier, Nordheim (DE)

Correspondence Address: MCNAIR LAW FIRM, PA, P.O. BOX 10827, GREENVILLE, SC, 29603-0827, US

(21) Appl. No.: 11/114,477

(22) Filed: Apr. 26, 2005

(30) Foreign Application Priority Data
Apr. 27, 2004 (DE) 102004020579.5

(51) Int. Cl. B29D 22/00

(52) U.S. Cl. 264/572; 425/130

(57) ABSTRACT

The present invention is directed to a system and method for manufacturing injection molded parts comprising an injection molding mold, at least one molten mass of synthetic material, at least one injection opening defined by the injection mold for first receiving a first fluid under overpressure, and secondly, receiving a second fluid under overpressure; and, for injecting the first fluid into the injection mold to form at least one cavity surrounded by at least one molten mass of synthetic material and injecting the second fluid into at least one cavity so that the wall thickness of the molten mass is reduced thereby reducing the wall thickness of the injection molded part.

### FIELD OF THE INVENTION

This invention is directed to a system and method for manufacturing injection molded parts and more specifically a system for injecting a first fluid and a second fluid to manufacture injection molded parts.

### BACKGROUND OF THE INVENTION

In synthetic material injection, molding procedures using internal steam or gas pressure, a mass of molten synthetic material that is injected into an injection molding mold. By injecting gas under pressure through an injection opening, the thermosynthetic material molten mass is distributed over the interior wall of the injection mold and, if necessary, the excess material is pressed via an excess port into an excess container provided for that purpose.

One advantage of the traditional process using internal gas pressure is that it results in an even distribution of the molten synthetic material over the inside of the injection mold, whereby a skin of molten synthetic material forms directly on the inside of the injection mold as well as on the transition to the cavity or the gas fillings. One disadvantage of the internal gas pressure procedure is that the cycle times are comparatively long since it generally takes a longer time until the injection molded part has sufficiently cooled and hardened so that it can be taken out of the injection mold.

Rather than gas, a fluid can be injected into the mass of molten synthetic material which then evaporates in the injection mold, with the mass of molten synthetic material being distributed evenly over the interior wall of the injection mold, forming the desired cavity. Due to the higher heating capacity of fluids as compared to gas, and in particular due to the fluid-gaseous phase transition point, the cycle times are shortened by this injection molding procedure.

In the manufacture of injection molded parts from synthetic material that must possess high mechanical stability, e.g., for components of motor vehicle mirrors, materials are used that make high process temperatures and pressures. It has been shown that in this injection molding process, sometimes spongy structures filled with fluid are produced from the mass of molten synthetic material. These injection molded parts do not possess the desired mechanical stability. Furthermore, these spongy structures still contain fluid that must be removed from the injection molded part in an additional work phase.

Injection molded parts can also be produced by means of a modified internal gas pressure procedure with at least one cavity. In order to shorten the cycle times, the completed injection molded part is subsequently rinsed out and thereby cooled, so that the cycle times can be shortened. However, the cycle time can be too long for industrial applications which need much shorter cycle times.

Therefore, the need to provide an improved procedure for the manufacturing of injection molded parts with completely or partially closed cavities made of synthetic material that would be characterized by shorter cycle times and an even build-up of the walls of the injection molded parts is needed.

### SUMMARY OF THE INVENTION

The above objectives are accomplished according to the present invention by a system and method for manufacturing injection molded parts comprising an injection molding mold, having at least one molten mass of synthetic material, at least one injection opening defined by the injection molding mold for first receiving a first fluid under overpressure, and receiving a second fluid under overpressure; at least one nozzle for injecting the first fluid into the injection mold to form at least one cavity surrounded by at least one molten mass of synthetic material and injecting the second fluid into at least one cavity so that the wall thickness of the molten mass is reduced thereby reducing the wall thickness of the injection molded part. Additionally, the system may include at least one nozzle for injecting the first fluid in a gaseous state and at least one nozzle is for injecting the second fluid in a liquid state. The system can include an excess port defined in the injection molding mold allowing for any excess of the at least one molten mass of synthetic material to exit the injecting molding mold. An excess port closing member can be carried by the injection molding mold for closing the excess port when injecting the first fluid and for closing the excess port when injecting the second fluid. The first fluid can be injected under a first pressure and the second fluid under a second pressure. Further, the first fluid can be injected at a first temperature and the second fluid at a second temperature.

A system can include a housing, an injection molding mold carried by the housing having at least one injection opening for receiving a molten mass of synthetic material, at least one nozzle carried by the housing for injecting the molten mass in the injection molding mold, an injection molding controller in communication with at least one nozzle having instructions for actuating at least one nozzle for injecting the molten mass of synthetic material through at least one injection opening, injecting a first fluid in order to form at least one cavity within the molten mass of synthetic material, and injecting a second fluid in the cavity for reducing the wall thickness of the injection molded part.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a flow chart illustrating the process; and

FIG. 2 is a schematic of the invention.

### DETAILED DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

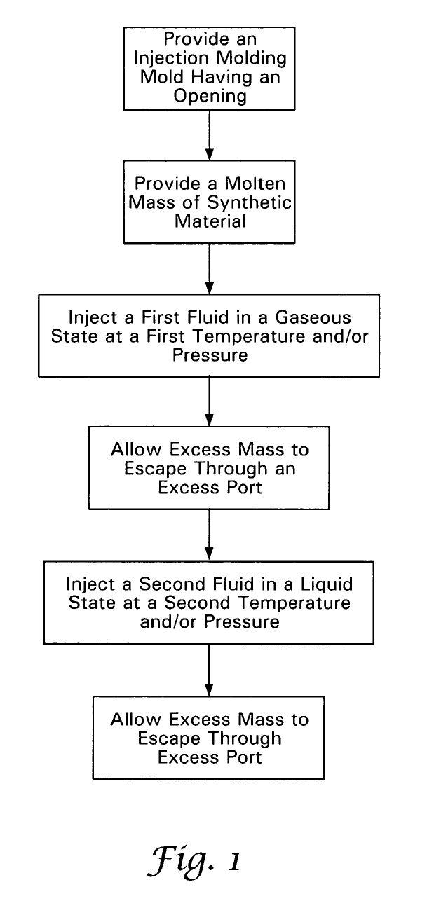

Referring now to the drawings, the invention will now be described in more detail. As shown in FIG. 1, the invention provides for the manufacturing of an injection molded part from a molten mass of synthetic material contained in an injection-mold for forming an injection molded part having entirely or partially closed cavities by providing an injection mold at step 10. A molten mass of synthetic material is received by the injection mold at step 12. Injection of gas or steam under overpressure, through at least one injection opening at step 14 forms at least one cavity surrounded by the mass of molten synthetic material whereby the mass of molten synthetic material begins to solidify, but remains plastically deformable. Subsequently, injecting a fluid at step 18 into the cavity surrounding by the molten synthetic material can further enlarge the cavity and further reduce the wall thickness of the injection molded part. It should be noted that the step of introducing gas or steam can be repeated. It should be noted that the step of introducing fluid can be repeated. Also, the introduction of gas or steam can be performed at a different pressure than the introduction of fluid. The introduction of gas or steam and fluid can be performed at different temperatures.

After the gas or steam is injected, excess molten synthetic material may escape through at least one excess port at step 16. After the fluid is injected, excess molten synthetic material may escape through at least one excess port at step 20. The excess port can be intermittently closed during the injection of the gas, steam or fluid.

The cavity in the molten synthetic material is formed by a conventional internal gas pressure procedure used to cause a smooth internal skin to be formed in the cavity of the molten mass of synthetic material. Next, fluid is introduced under pressure and since fluid is essentially non-compressible, it reduces the wall thickness of the injection molded part further, i.e., the cavity or cavities are further expanded. In this procedure, the process parameters such as pressure, duration of the first step, temperature, etc. are selected so that when the fluid is introduced in the second step, this fluid no longer or barely evaporates. In this manner, the smooth internal surface of the injection molded part is preserved. Since fluids are non-compressible, a more uniform application of pressure on the synthetic material takes place than with gas, and as a result a more uniform wall thickness of the injection molded part is obtained. In addition, the introduction of fluid into the injection molded part in one work phase further forms the injection molded part and at the same time cools it. Effective cooling of the injection molded part and desired imparting of form therefore take place in the same procedure step.

Excess mass of molten synthetic material can be directed via an excess port with an excess port valve into an excess container dedicated for that purpose and is thereby pushed out of the cavity and out of the injection molded part during the introduction of gas as well as during the introduction of fluid. This pushing out of excess molten synthetic material takes place, in particular, during the first procedure step, during the introduction of gas.

The excess port can be closed at least intermittently during the introduction of gas or of fluid. Thereby, the uniform formation of the wall thickness can be influenced in a targeted manner.

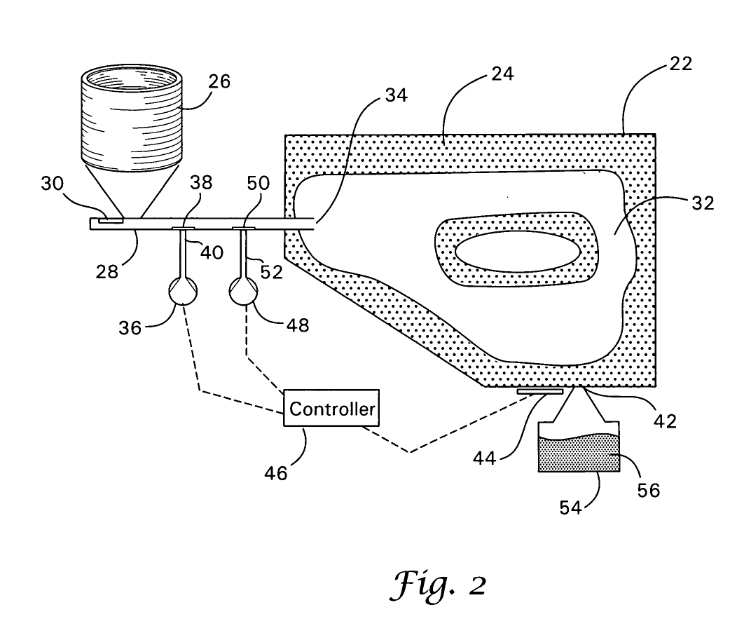

Referring now to FIG. 2, the apparatus will be explained in more detail. Injection mold 22 is shown containing molten synthetic material 24 that is received from source 26 and enters the injection mold through a pathway 28 into the injection mold. When molten synthetic material is being injected, source valve 30 is in an open position allowing the synthetic material to enter pathway 28. Once a sufficient amount of material is received in the injection mold, source valve 30 is placed in a closed position thereby disallowing synthetic material to enter pathway 28 from source 26.

When the injection material is received by the injection mold, cavity 32 can be defined within the molten synthetic material. This cavity is in communication with at least injection opening or injection port 34 which is also in fluid communication with pathway 28. A first fluid source 36 can be in fluid communication with pathway 28 allowing a first fluid to be injected into the cavity. Once a first fluid is injected, molten synthetic material 24 is forced against the wall of the injection mold thereby increasing or originally forming cavity 32. First source valve 38 is in an open position allowing a first fluid from fluid source 36 to enter pathway 28 through a first nozzle 40. The first fluid can be injected into cavity 32 at a first pressure, a first temperature or both and can inject fluid in a gaseous or liquid state. When injecting fluid, the first source valve is open and the source valve is closed. In the event that injection of the first fluid results in excess molten synthetic material, excess port allows excess molten material to exit the injection mold. Excess port valve 44 can be in a closed position upon initial injection of the first fluid to allow sufficient pressure to build up in the injection mold and subsequently be opened to allow excess material to exit the injection mold. Excess port valve can be in an open or closed position at each stage of the injection molding process as needed to relieve the injection mold from excess material. Excess container 54 can contain excess synthetic material 56 once it has exited the injection mold.

A second fluid source 48 can also be in fluid communications with pathway 28 and have a second source valve 50 having an open and closed position to allow or prevent fluid from entered pathway 28 from second fluid source 28. The second fluid source can have a second nozzle 52. The second fluid can be in a gaseous or liquid state and can have a second temperature or second pressure or both.

In operation, the source valve is open while the first and second fluid source valves are closed. The port closure member can be in an open or closed position. Once the synthetic material is received by the injection mold, the first fluid source valve is open and the excess port and source valves are in a closed position. A first fluid is injected into the injection mold. Next, the excess port valve can be opened. Next, the first fluid source and port valves are in a closed position and the second fluid source valve is opened. A second fluid is injected into the injection mold. Next, the excess port valve can be opened. Once completed, the injection mold part is removed from the mold.

The excess valve, as well as source 26, source valve 30, first fluid source 36, and first fluid source valve 38, second fluid source 48, and second fluid source valve 50 can be in communication with controller 46 and be controlled, through computer readable instructions, by the controller.

While a preferred embodiment of the invention has been described using specific terms, such description is for illustrative purposes only, and it is to be understood that changes and variations may be made without departing from the spirit or scope of the following claims.

1. A system for manufacturing injection molded parts comprising:
an injection molding mold having at least one molten mass of synthetic material;
at least one injection opening defined by said injection molding mold for injecting a first fluid under overpressure to form at least one cavity surrounded by said at least one molten mass of synthetic material and secondly injecting a second fluid under overpressure so that the wall thickness of said molten mass is reduced thereby reducing the wall thickness of said injection molded part; and,
an excess port defined in said injection molding mold allowing for any excess of said at least one molten mass of synthetic material to exit said injecting molding mold.

2. The system of claim 1 wherein said at least one nozzle is for injecting said first fluid in a gaseous state and injecting said second fluid in a liquid state.

3. The system of claim 1 including an excess port valve carried by said injection molding mold for closing said excess port when injecting said first fluid and closing said excess port valve when injecting said second fluid.

4. The system of claim 1 wherein said at least one injection opening is for injecting said first fluid under a first pressure and said second fluid under a second pressure.

5. The system of claim 1 wherein said at least one injection opening is for injecting said first fluid at a first temperature and said second fluid at a second temperature.

6. A method for manufacturing injection molding parts comprising the steps of:
providing an injection molding mold;
providing a molten mass of synthetic material within said injection molding mold;
injecting a first fluid under overpressure in said molten mass of synthetic material to form at least one cavity; and,
injecting a second fluid under overpressure in said molten mass of synthetic material for further enlarging said cavity so that the wall thickness of said injection molded part is reduced.

7. The method of claim 6 wherein said step of injecting a first fluid includes injecting said first fluid in a gaseous state and said step of injecting a second fluid includes injecting said second fluid in a liquid state.

8. The method of claim 6 wherein said step of injecting said first fluid is performed at a first pressure and said step of injecting said second fluid is performed at a second pressure.

9. The method of claim 6 wherein said step of injecting said step of injecting said first fluid is performed at a first temperature and said step of injecting said second fluid is performed at a second temperature.

10. The method of claim 6 including the step of allowing excess mass of said molten synthetic material to escape through at least one excess port.

11. The method of claim 6 including the step of closing said at least one excess port during the injection of said first fluid.

12. The method of claim 6 including the step of closing said at least one excess port during the injection of said second fluid.

13. An injection molded part made from the method of claim 6.

14. An injection molded motor vehicle mirror part made from the method of claim 6.

15. A system for manufacturing injection molded parts comprising:
a housing;
an injection molding mold carried by said housing having an injection opening;
a source of synthetic material in fluid communication with said injection opening allowing synthetic material to be received by said injection molding mold;
a first fluid source in fluid communications with said injection opening for allowing a first fluid to be injected into said injection molding mold;
a second fluid source in fluid communication with said injection opening for allowing a second fluid to be injected into said injection molding mold;
an excess port defined in said injection molding mold for allowing excess molten synthetic material to exit said injection molding mold;
an excess port valve carried by said excess port having an opened position and a closed position;
a controller in communication with said fluid source, said second fluid source, and said excess port valve having computer readable instructions for actuating said source for injecting a molten mass of synthetic material through said at least one injection opening, injecting a first fluid from said first fluid source into said injection mold to form at least one cavity within said molten mass of synthetic material, injecting a second fluid from said second fluid source into said cavity for reducing the wall thickness of said injection molded parts, opening said excess port valve to allow excess synthetic material to exit said injection molding mold and closing said excess port valve when injecting said first fluid and said second fluid.

16. The system of claim 15 wherein said controller includes instructions for injecting said first fluid at a first pressure and said second fluid at a second pressure.

17. The system of claim 15 wherein said controller includes instructions for injecting said first fluid at a first temperature and said second fluid at a second temperature.

18. The system of claim 15 wherein:
said source of synthetic material is in communication with said controller; and,
said computer readable instructions include instructions to actuate said source for injecting synthetic material into said injection molding mold.

19. The system of claim 15 wherein said injection molding mold is for making a vehicle part.

20. The system of claim 19 wherein said injection molding mold is for making a vehicle mirror part.
